(19) United States
(12) Patent Application Publication
(10) Pub. No.: US 2004/0125855 A1
(43) Pub. Date: Jul. 1, 2004

(54) Electronic water temperature measuring apparatus

(76) Inventor: Yi-Chia Liao, Hsinchu City (TW)

Correspondence Address: BIRCH STEWART KOLASCH & BIRCH, PO BOX 747, FALLS CHURCH, VA, 22040-0747, US

(21) Appl. No.: 10/331,981

(22) Filed: Dec. 31, 2002

(51) Int. Cl. G01K 7/00

(52) U.S. Cl. 374/170

(57) ABSTRACT

An electronic water temperature measuring apparatus includes a main body formed in a desired shape. The main body has a measuring circuit to measure water temperature and a liquid crystal display device located on the surface to display the water temperature for user viewing. The main body further has a temperature setting button and an operation time setting button to prevent users from scalding or physical suffering caused by too high or too low of water temperature, and to control bathing time for children to save water consumption.

### FIELD OF THE INVENTION

The present invention relates to a water temperature measuring apparatus and particularly an electronic water temperature measuring apparatus.

### BACKGROUND OF THE INVENTION

In the past measuring water temperature is usually done by using a thermometer. The thermometers generally can be grouped in mercury type, alcohol type or electronic type. The mercury thermometer contains mercury which is toxic and could become hazardous to human being when it is spilled out during cleaning. The alcohol thermometer is safer but is less accurate for measuring temperature. The electronic thermometer employs electronic elements to measure water temperature. It is more accurate and safer to use.

However, conventional thermometers mentioned above all have a plain and monotonous design. Moreover, they can only measure water temperature, but cannot predict water temperature. The temperature is known only after the measurement has been finished. It could become too late. For instance, for the children, people of old age or patients to take bath, not knowing the water temperature in advance could result in scalding or physical suffering. It could even put people's life in risk in severe situations. Hence to develop an electronic apparatus that can measure and predict water temperature to enhance safety, and be made in versatile forms such as toys to increase appealing, and equip with alert functions when the water temperature is too hot or too cold is an important issue.

### SUMMARY OF THE INVENTION

Therefore the primary object of the invention is to provide improvements for the conventional water temperature measuring apparatus now available on the market. The invention aims at providing an electronic water temperature measuring apparatus that includes a main body formed in a desired shape. The main body contains a measuring circuit for measuring water temperature, a liquid crystal display (LCD) device to display temperature reading for users to see, a temperature setting button and an operation time setting button. By means of the invention, users may be prevented from exposing to water temperature that is too high or too low to avoid scalding or physical suffering. And bathing time for children may be controlled to save water consumption.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of the main body of the invention.

FIG. 2 is a block diagram of the measuring circuit in the main body of the invention.

FIG. 3 is the measuring circuit diagram of the invention.

### DESCRIPTION OF THE PREFERRED EMBODIMENT

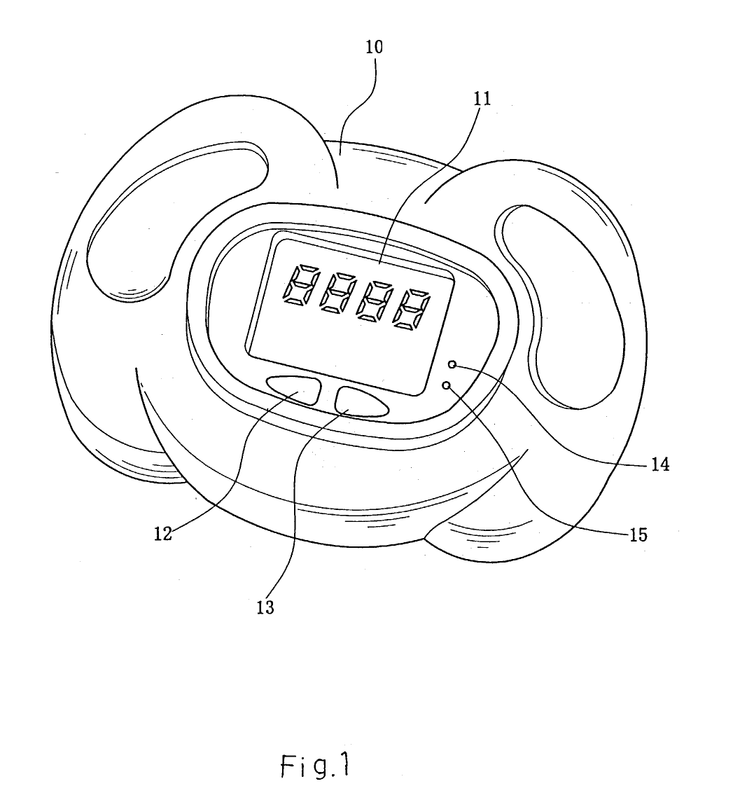

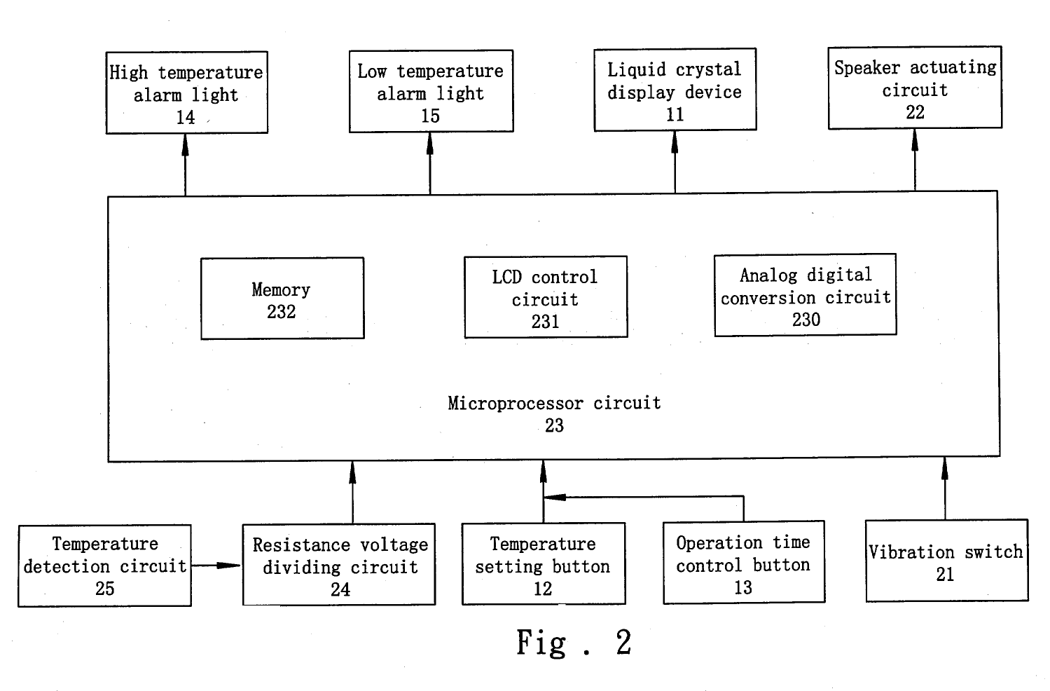

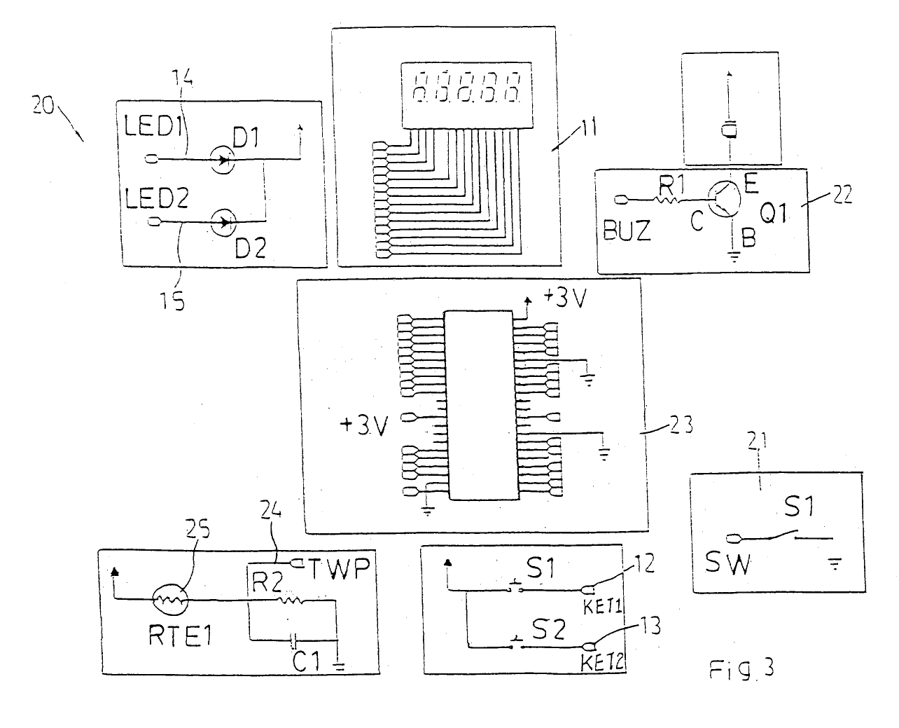

Referring to FIGS. 1, 2 and 3, the invention includes a main body 10 formed in a desired shape. The main body 10 has a LCD device 11, a temperature setting button 12, an operation time control button 13, a high temperature alarm light 14 and a low temperature alarm light 15 located on the surface thereof.

Inside the main body 10, there is a measuring circuit 20 which includes a vibration switch 21, a speaker actuating circuit 22, a microprocessor circuit 23, a resistance voltage dividing circuit 24, and a temperature detection circuit 25. The temperature detection circuit 25 is located at the bottom of the main body 10 to facilitate measuring of water temperature.

When in use, dispose the main body 10 on water surface (floating on water surface), and activate the main body 10. The activation of the main body 10 may be done by the following methods:

The first approach, when the main body 10 is in a still condition, the microprocessor circuit 23 is sleeping (i.e. OFF state). When the vibration switch 21 detects that the main body 10 is shaking, depending on the shaking cycle, a signal is continuously sent to the microprocessor circuit 23. The microprocessor circuit 23 receives the signal and enters an operation condition (i.e. ON state). By contrast, if the microprocessor circuit 23 does not receive the signal from the vibration switch 21 for a period of time (such as three minutes), it enters the sleeping condition (i.e. OFF state).

The second approach, depress any button (such as the temperature setting button 12 or operation time control button 13) to activate the microprocessor circuit 23.

When the microprocessor circuit 23 operates, the temperature detection circuit 25 transforms water temperature variations to resistance variations (the higher the water temperature, the lower the resistance becomes). The resistance variations are connected to the resistance voltage dividing circuit 24 to obtain a voltage. The voltage and temperature variation has a corresponding relationship which is fed to an analog digital conversion circuit 230 in the microprocessor circuit 23 to transform to a temperature value. Then the temperature value is displayed on the LCD device 11 through a LCD control circuit 231 in the microprocessor circuit 23 for user viewing.

It is to be noted that the invention also has a “temperature setting function” to enable users to set water temperature. When the temperature setting button 12 is depressed continuously for a selected time period (such as five seconds), the temperature may be set. The set temperature is recorded in a memory 232. The microprocessor circuit 23 compares measured temperature with the temperature value in the memory 232 after a selected time period, and displays the comparison results on the LCD device 11 by scale. If the water temperature is higher than the temperature value in the memory 232, the microprocessor 23 generates an alarm music through the speaker actuating circuit 22, and the high temperature alarm light 14 also blinks to alert users that water temperature is too high. On the contrary, if water temperature is lower than the temperature value in the memory 232 for a selected degree, the microprocessor circuit 23 also generates another type of alarm music through the speaker actuating circuit 22, and the low temperature alarm light 15 also blinks to alert users that water temperature is too low.

In addition, the invention provides an “operation time control function” (by the unit of minute). When the operation time control button 13 is depressed for a selected time period (such as five seconds), the microprocessor circuit 23 receives the signal and enters a time setting mode. The LCD device 11 indicates a number (such as 1). Depress the operation time control button 13 one more time, the number increases by one (i.e. the number on the LCD device becomes 2). The depressing action may be repeatedly performed on the operation time control button 13 until the number exceeding a certain number (such as 30), then the number returns to one again. After the number is set, the microprocessor 23 starts counting in a reverse manner. When the number becomes zero, the speaker actuating circuit 22 generates alarm music to alert the user that bathing time is up. After a selected time (such as 60 seconds), the main body 10 enters the sleeping condition (i.e. OFF state).

By means of the construction set forth above, the invention can achieve the following effects:

Through the temperature setting button 12, users (especially children) may be prevented from scalding or physical suffering caused by too high or too low of water temperature resulting from people's negligence. The operation time control button 13 may be used to set time limit of bathing to remind adults and to prevent children from taking bath too long to save water consumption.

What is claimed is:

1. An electronic water temperature measuring apparatus comprising a main body wherein the main body includes a measuring circuit, a liquid crystal display device, a temperature setting button, an operation time control button, a high temperature alarm light and a low temperature alarm light;
the temperature setting button for comparing current water temperature with a water temperature value stored in a memory of the microprocessor circuit and displaying the comparing result on the liquid crystal display device;
the operation time control button which has a timing mode for controlling operation time of the main body to alert bathing time, and the microprocessor circuit generating an audio alarm through the speaker actuating circuit when reverse time counting having reached zero and the main body entering a sleeping condition after a selected time period;
the high temperature alarm light and the low temperature alarm light for shining blink light;
the measuring circuit further includes:
a temperature detection circuit for transforming water temperature variations to resistance variations, and displays temperature value on the LCD device;
a resistance voltage dividing circuit for transforming resistance variations to voltage;
a microprocessor circuit includes an analog digital conversion circuit, a LCD control circuit and a memory, which is mainly for receiving and sending signals from each circuit, for controlling the operation of the main body;
a speaker actuating circuit for generating alarm music.

2. The electronic water temperature measuring apparatus of claim 1, wherein the measuring circuit further includes a vibration switch detects that the main body is shaking, depending on the shaking cycle, a signal is continuously sent to the microprocessor circuit.

3. The electronic water temperature measuring apparatus of claim 1, wherein the analog digital conversion circuit for transforming voltage to temperature value;
the LCD control circuit for displaying temperature value;
the memory for storing signals from each circuit and the measured temperature value.
